(19) United States
(12) Patent Application Publication
(10) Pub. No.: US 2013/0251332 A1
(43) Pub. Date: Sep. 26, 2013

(54) METHOD AND SYSTEM FOR THE AUTOMATIC RECORDING OF A MOVING SUBJECT

(71) Applicants: Alessandro Giacomelli, Vicenza (IT); Carlo Basci, Chiuro (IT); Stefano Piermatteo, Vicenza (IT); Davide Zeffiro, Montegalda (IT)

(72) Inventors: Alessandro Giacomelli, Vicenza (IT); Carlo Basci, Chiuro (IT); Stefano Piermatteo, Vicenza (IT); Davide Zeffiro, Montegalda (IT)

(73) Assignee: ONTARIO 1762760 LTD, North Bay, ON (CA)

(21) Appl. No.: 13/992,632

(22) PCT Filed: Dec. 6, 2011
(86) PCT No.: PCT/IB11/55480

§ 371 Date: Jun. 7, 2013

(30) Foreign Application Priority Data
Dec. 9, 2010 (IT) CO2010A000065

(51) Int. Cl. H04N 9/79

(52) U.S. Cl. CPC H04N 9/79
USPC 386/228

(57) ABSTRACT

The method for automatically recording a moving subject (SM) associated to an electronic radio frequency identification device (TG) containing identification data of said subject (SM), comprises, in order, the following steps to be carried out at least once: A) automatically carrying out an identification of said subject (SM) via said identification device (TG) when said subject (SM) enters a predefined recording zone (ZP, Z1, Z2, ZA); B) automatically carrying out a recording via a recording device (CP, C1, C2, CA) following identification, thus obtaining a recording component; C) associating identity data deriving from identification of the subject (SM) to the recording component; a route taken by the moving subject (SM) is defined according to a predefined procedure on the basis of the predefined recording zones (ZP, Z1, Z2, ZA) that the moving subject (SM) has entered; route information is associated to the recording components deriving from step C), thus creating an event of the moving subject (SM); said method can be executed through a specific system.

### FIELD OF THE INVENTION

This invention relates to a method and a system for the automatic recording of a moving subject.

This invention is especially advantageous when there are a plurality of moving subjects within a large area and recordings of one or more of these subjects are to be recorded when the subject passes through one or more smaller zones within said large area. In addition, this invention advantageously allows the immediate use of the recordings, in particular as soon as said subject has passed through said large area and possibly even as soon as said subject has passed through said smaller zone.

Typically, this invention will be used to create video recordings. Nevertheless, still images should not be excluded; still images are not preferred for reasons that will become clear below.

### BACKGROUND OF THE INVENTION

When manual recordings of a moving subject are to be made (e.g. a skier descending a ski slope), the operator identifies the subject when he/she is at a distance, prepares to record then records the subject when he/she passes through the recording zone (e.g. a jump on a ski slope); this can be repeated for all subjects passing through the recording zone. If recordings are to be made in a plurality of zones, one operator is required for each zone. All recordings (e.g. video footage) created in a specific time period (e.g. two or three hours) will remain in the recording device used (e.g. a video camera) and can be transferred to a computer (e.g. a personal computer) as electronic files. The user of the computer is responsible for managing the electronic files (AVI, WMV, MPG, BMP, JPG and so forth) for the footage; in general, this takes place in summary fashion, and is limited to dividing the files on the basis of the recording date, sometimes sub-dividing by morning and afternoon.

There are also existing methods and apparatus for the automatic recording of moving subjects.

In particular, US2010/0182436A1 refers to a method and to apparatus for the automatic recording of a moving subject through recording devices, which detect the subject's movement, in particular through a recording device. Said subject is identified via an identification device and such identification data is then associated to the recording.

US2006/0095340A1 describes a method and an apparatus for the identification of a moving subject and the creation of multimedia data (such as video recordings) associated to said identification; the data is then transferred to a remote device for storage; access to said data takes place via the acquisition by said remote device of a remote storage medium onto which said data is placed (e.g. a DVD containing the video recordings of a moving subject).

US2004/0201738A1 describes a method and an apparatus for the automatic photographing of moving subjects. Said subjects are uniquely identified and photographs are taken, which are associated to previously obtained identification information and stored in a database. Access to said database envisages the checking of credentials and allows photographs of the subject to be obtained.

### SUMMARY OF THE INVENTION

With reference to the first document (US2010/0182436A1), it has been noted that the subject is only recorded if he/she follows a fixed, pre-determined route.

The second document (US2006/0095340A1) does not envisage circumscribed recording zones for the subject and thus the route taken by a moving subject is irrelevant.

In document three (US2004/0201738A1), a plurality of photographs are taken without any consideration for the route taken by the moving subject.

In addition, in all three of the aforementioned documents, access to the recordings does not take place immediately on conclusion of the activity of the subjects to be recorded. Indeed, in order to access the recordings, it is necessary to access the system, either in person, if physically in proximity thereto or remotely, via internet, following execution of the necessary technical operations for the placing of the recordings onto a system for the sharing and access thereof (a file server for example). It should be taken into account that the system used to access the recordings can be located even at a distance from the location in which said recordings are to be made and that, additionally, internet network connectivity may not be available in proximity to the place in which the recordings are made.

The general aspect of this invention is to improve the prior art, in particular by taking into account the route taken by the moving subject, although not rigidly.

An initial, more specific aspect, is to remove the need for an operator to take the recordings; indeed, an operator can easily commit errors, such as identifying a delay in the moving subject or delaying or making recording errors; furthermore, there is a risk of the operator colliding with the moving subject who is to be recorded or with other moving subjects in the vicinity.

A second, more specific aspect is to remove the need for a plurality of operators; indeed, where such a presence can be just justified in certain, specific situations, such as at an important sports event, it is not generally justified in many other situations, such as if the recordings are made for teaching or leisure purposes; a sportsman/sportswoman may wish to be recorded to retrospectively check if his athletic moves are adequate or if they can be improved upon; a person may wish to be recorded to show the recordings to his/her friends.

A third, more specific aspect, is to record selective recordings, in particular to record just a few of the moving subjects, such as for example, recording those subjects who have specifically asked to be recorded, who could be called “users”, and not recording all the other subjects.

A fourth, more specific aspect is to simultaneously and independently manage a plurality of moving subjects.

A fifth, more specific aspect is to facilitate the select identification of recordings, for example to identify the recordings relating to a subject from among all recordings; this would for instance facilitate the provision of copies of the recordings to only the recorded subject.

A sixth, more specific aspect is to facilitate the direct access to the recordings by the recorded subjects, more or less in real time.

A seventh, more specific aspect is to facilitate payment of the recordings by the recorded subjects via electronic credit.

An eighth, more specific aspect is to facilitate and increase educational efficacy in the teaching of sporting disciplines.

A ninth, more specific aspect is to provide a high quality method and system for the recording of sporting activities.

A tenth, more specific aspect is to allow immediate access to the recordings.

An eleventh, more specific aspect is to allow access to the recordings in the immediate vicinity of the place in which the recordings were made.

These and other aspects are achieved due to the method and the system having the features as set out in the annexed claims, which are an integral part of this description.

The idea behind this invention is the automatic recording of a subject when said subject has been detected in a recording zone by an electronic radio frequency identification device

Depending on the size of the area and the number of moving subjects, a certain number of detection devices and recordings will be envisaged.

This approach makes detection of the subject to be recorded, easy, simple and effective and does not require complex image processing software.

This approach allows fixed recordings with a fixed recording field and perhaps even fixed-focus (these three parameters will be typically configured during installation); this significantly simplifies their structure and control.

The method and the system according to this invention make it possible to provide a recording service (via payment, for example); typically, the persons intending to use such a service must submit a request, thus becoming service “users”; as will become apparent from the detailed description, “ordinary users” and “privileged users” could be envisaged.

In general, the method according to this invention serves to automatically record a moving subject; the subject is associated to an electronic radio-frequency identification device, which contains identification data relating to said subject; the method comprising the following steps carried out at least once:
A) automatically carrying out an identification of said subject (SM) via said identification device when said subject enters a predefined recording zone,
B) automatically carrying out a recording via a recording device following said identification, thus obtaining a recording component,
C) associating to said recording component, identity data deriving from said step A;
   wherein
   a route is defined taken by said moving subject (SM) in accordance with a predefined procedure on the basis of the predefined recording zones (ZP, Z1, Z2, ZA) that said moving subject has entered, and then
   the recording components deriving from said step C relating to said route are associated to information relating to said route, thus creating an event of said moving subject (SM).

Steps B and C can only be achieved if the identification data from said stage A are correct. In particular, said identification data is deemed to be correct if the moving subject has been correctly associated to the electronic identification device and/or he/she has an electronic credit to him/her attested. Said check relating to the correctness of the identification data obtained from said step A is carried out each time the moving subject passes through a predefined recording zone. This feature prevents the recording of subjects whose electronic credit is insufficient for access to the service.

The start zone and the arrival zone are determined on the basis of said predefined procedure wherein a recording component associated to said start zone is the first recording component of said event, and wherein a recording component associated to said arrival zone is the last recording component of said event. This allows a dynamic route to be achieved, that is, a route that has not been predetermined, which the user is free to follow while still being able to access the service.

A plurality of predefined recording zones and a corresponding plurality of recording devices may be provided. In addition, at least two recording devices may be associated to a predefined recording zone thus capturing at least two corresponding perspectives.

Additionally, step C also provides to associate to a recording component also information relating to the time and date wherein the recording was made, and/or to identity information relating to the recording device that created the recording, and/or to informations obtained by process of the recording

Execution of the predefined procedure may provide assessment of the below criteria:
number of detections of a moving subject in one or each predefined recording zones in a predetermined time,
elapsed time between identification of a moving subject in different, predefined recording zones,
at least a predefined order in the plurality of recording zones.

Said criteria allow the dynamic management of the route taken by a subject, without restrictions associated to the mandatory passage through a predetermined start or arrival zone.

Subsequently, the event thus created is stored on a computer and is made available by the computer for selective remote access. Alternatively a subject can use the various events associated to him/her, without having to directly access the physical resources of the computer, but for example by accessing the events via a WLAN wireless connection or a LAN cable connection.

Access to the computer can take place through the preventive check of login credentials. In addition, in accordance with an alternative embodiment wherein the events are accessed by a subject through a visualization device, the login credentials derive from the electronic identification device.

Furthermore, selective remote access to the computer can take place through a software application for mobile communication devices, such as smartphone or tablet pc for example.

Alternatively, a subject may use the event associated to him/her via a playback device, such as a monitor comprising a multimedia file reader.

Said playback device may further comprise an interface for receiving and interpreting gesture commands, for instance via a Kinect device.

Access to events can take place immediately after their creation, thus advantageously allowing immediate access to the events.

Alternatively, the event may be transferred by the computer to a server for selective access via a public computer network, particularly internet.

Said steps A, B and C can be executed in relation to a plurality of moving subjects, each associated to a corresponding electronic radio frequency identification device containing his/her identification data. In this case, advantageously, said several moving subjects may be simultaneously and independently managed.

In general, the system according to this invention serves to automatically record a moving subject; said subject is associated to an electronic radio frequency identification device containing identification data relating to said subject; said system comprises:
at least one detection device, adapted to detect the presence of an electronic radio frequency identification device in a predefined recording zone (said zone could be located for instance at a point or at a hypothetical route of said moving subject).
at least one recording device adapted to create recordings in said predefined recording zone.
a computer connected to said devices;
   said system is especially adapted to carrying out of the method according to this invention, in particular via a processor program installed or integrated in said computer.

The system according to this invention can further include specific means for creating specific features of the method pursuant to the invention.

The system according to this invention can further include a plurality of detection devices and a corresponding plurality of recording devices; said detection devices and said recording devices are connected to said computer.

The system according to this invention can further include one or more devices that are respectively associated to one or more recording devices and are adapted to emit a signal if a recording has been made; this can take place through an acoustic and/or visual signal; said signal shall typically be emitted to alert the moving subject that he/she has been recorded.

The system according to this invention can further include one or more lighting devices associated and controlled by said computer; said lighting devices could for instance be activated only when recording is underway.

The system according to this invention can further include an electronic radio-frequency communications device associated to said computer, which is adapted to allow said computer to communicate with user mobile radio-terminals; said device can, for instance, be a Wi-Fi Access Point. This feature can be used for radio-frequency access to the recordings stored on the computer via the user's mobile radio-terminals.

The system according to this invention can further include an electronic communications device associated to said computer, which is adapted to allow said computer to communicate with a server; said device can, for instance, be an ADSL Modem. This feature can be used to transfer the recordings from said computer to said server.

The system according to this invention can also further include the server associated to said computer and to a public computer network, such as internet in particular. This feature can be used to implement a user's main or sole access to the recordings.

Said computer and/or said server can be associated to a public computer network such as internet in particular. This technical feature can be used, for example, to implement an electronic bank payment system.

The system according to this invention can further include means of communications of a local computer network (LAN) that connects said computer to said devices; a local computer network is the most simple and practical way to create said connection; this can be done via a Router or a Switch, for example. In this case, it is advantageous that the various aforementioned devices integrate a network card and, possibly, an intelligent control unit; this is especially true for the recording devices.

In the foregoing paragraphs there are several references to connections between electronic devices; depending on the specific cases and on how this invention is implemented in practice, these connections can be the same or may differ one from the other; for example, they can be direct or indirect, or via radio-frequency or cable (electric wire or fibre optic).

### LIST OF DRAWINGS

The technical features of this invention and its benefits shall become apparent from the below description to be considered together with the attached drawing, wherein:

FIG. 1 is a schematic view of an environment in which this invention can be used and of several components of an embodiment of the system according to this invention.

FIG. 2 is a block diagram of an embodiment of a system according to this invention.

FIG. 3 is a flow chart relating to the use of a system according to this invention.

### DETAILED DESCRIPTION

Both said description and said drawings are to be merely considered for illustrative purpose and are not exhaustive; this invention may therefore be implemented according to other and different embodiments; furthermore, it must be taken into account that said figures provide schematic and simplified views.

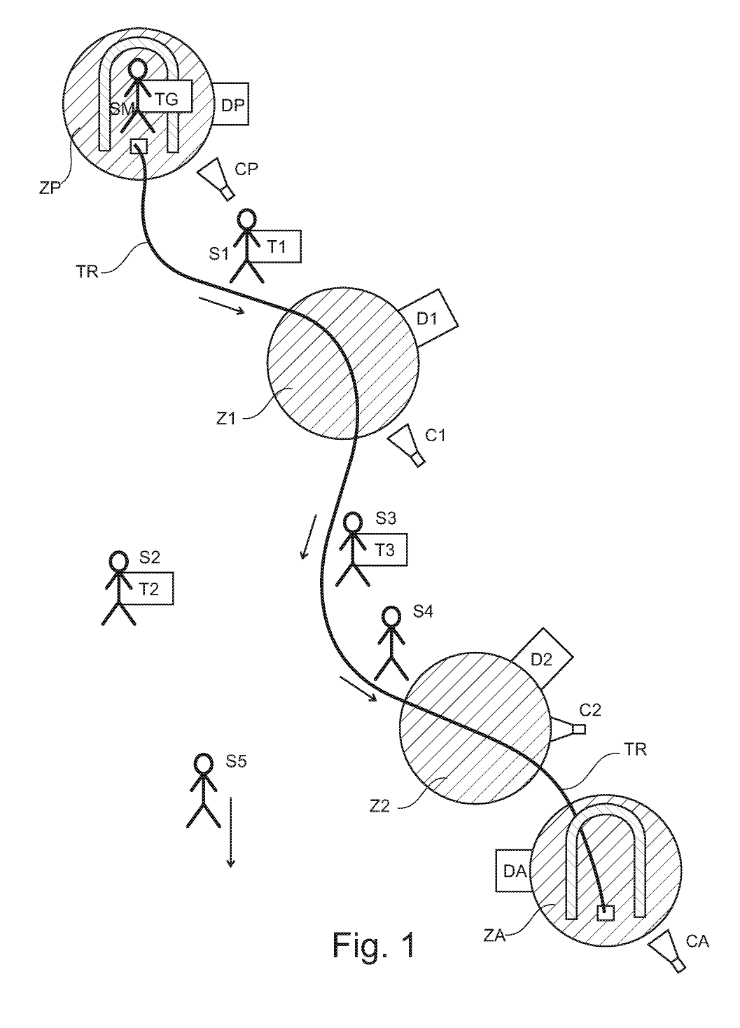

FIG. 1 shows a large area in which a plurality of subjects moving within said area are performing a sporting activity; this figure can correspond, for instance, to a ski slope with five skiers. It is proposed that these skiers be opportunely and automatically recorded.

FIG. 1 shows a generic moving subject SM, in particular a man engaging in a sporting activity, associated to an electronic radio frequency identification device TG containing identity data of the subject SM. The device TG is, in particular, an RFID [Radio-frequency Identification] tag, that operates in a semi-passive UHF radio-frequency (i.e. it is equipped with a small battery to ensure the most reliable operation particularly in the transmission stage, due to the increased available power).

Operation of the RFID systems is known to sector technicians; a detailed description is not therefore provided.

The device TG remains inactive until “interrogated” by a detection device; this takes place when the device TG enters the coverage zone of a device TG. Essentially, the detection device comprises a reader and an antenna. Following “interrogation” by a detection device, the device TG transmits a response to the detection device containing the identification data of the subject SM; depending on the embodiment of this invention, said identification data can include the subject's identification data (e.g. an identity code for the subject) or identity information for the identification device associated to the subject (e.g. an identity code for the device) or identity data for both the subject and the device.

FIG. 1 shows subjects S1, S2 and S3 who, like the generic subject SM, are moving and lined to their respective identification devices, T1, T2, T3, containing their identification data; FIG. 1 also shows subjects S4 and S5, who are moving, but who are not associated to any identification device.

In relation to the foregoing, it must be assumed that the subjects S1, S2 and S3 are “users” of an “recording service” and have thus received the respective devices T1, T2 and T3 from the service manager; when delivering an identification device to an individual, the manager can record, on a computer or on a server, the identity data of the delivered device and identity data of the individual (in this case the identity of the person coincides with the identity of the device until, for example, the device is redelivered to the manager) or he/she can store the individual's identity data in the device (other information, such as information relating to a registration providing access to sports complexes, can be stored in said devices); during delivery, the manager will typically notify the individual of his/her login credentials (e.g. enter “user” and “password”, which will allow the user to access the recordings; during delivery, the manager shall be expected to request personal information from the individual, such as name, surname, address, etc., credit card number (said information shall not typically be stored in the identification device), also for the purposes of possible payments, and will store such information, in compliance with the privacy law, on a computer or on a server; subjects S4 and S5, without identification devices, are not therefore classed as “users”.

The “recording service” will be typically a paid service and it is thus important that only “users” have access to this service and that each “user” only has access to the service within the limits of what he/she has paid or is willing to pay. For example, when registering for the service, the manager could ask the customer (who becomes the “user” of the service) how many recordings he wishes to be recorded and may, consequently, request advance payment thus resulting in an initial credit from which payments will be deducted, or could request that the customer provide his/her credit card details or electronic system details for electronic payments (e.g. Paypal®) and if the customer requires a specific or unlimited number of recordings to be made in a predetermined time period (one afternoon, one day, one, week and so forth) to be billed to his/her credit card. It must also be taken into consideration that the payment can be associated to the recording and/or to use of the recording; for example, a small (or nil) cost can be set for the taking of the recording and a greater cost for use of the recording, as well as different costs based on the type of use (viewing, downloading and so forth).

Another factor to be taken into consideration is the privacy law: on the one hand, it is best to avoid recording people without their consent, on the other hand it is best to avoid providing recordings of an individual to another individual without his/her approval; in this regard, one special case is, for example, that of a sport instructor who, for teaching purposes, needs to see the recordings of his/her pupils—the sport instructor could, for example, be a “privileged user”. In addition, the privacy law also sets out a maximum time period within which the recordings of a “user” may remain in the memory of the computer systems used by this invention, on the expiry of which time period the recordings must be removed. Said time period varies on the basis of on each country's legislation. Specific “user” consent must be requested in order to store the recordings of a “user” for a period of time that is longer than that permitted.

As previously mentioned, subjects are free to move within the area as set out in FIG. 1, however a hypothetical route TR, which the subjects must follow, has also been defined; route TR commences from a start zone ZP at a start “gate”, passes through an initial zone Z1 and a second zone Z2 and ends at an arrival zone ZA, at an arrival “gate”.

Very often, the subjects will follow route TR (even where route TR is indicated by a line, this is to be understood as a wide strip); this is the case of moving subjects S1, S2 and S3 who are at different points of route TR. Nevertheless, nothing prohibits a subject from stopping at a distance from route TR, as is the case of subject S2, or from moving at a distance from route TR, as is the case of subject S5, or from starting his/her movement in the area at a distance from zone ZP, or from ending his/her movement in the area at a distance from zone ZA.

Each predefined recording zone ZP, ZA, Z1 and Z2, is respectively covered by detection devices DP, DA, D1 and D2.

Reference is now made to radio-frequency coverage, which allows the detection device to detect the presence of an identification device in the zone.

The identification devices and detection devices are of a type suitable for fairly long-distance communication (typically 3-6 m, in part due to their internal battery) so that they may be placed at a distance, thus limiting the risk of collision with moving subjects. For instance, products produced by the company SICK AG or by IMPINK INC can be used for RFID UHF systems; the dimensions of the identification devices, in particular the RFID tags, can be those of a credit card, for example (perhaps slightly thicker if they are equipped with a small battery) or of a packet of cigarettes, and can therefore be easily carried by moving subjects.

Zones ZP, Z1, Z2, ZA are respectively covered by recording devices CP, C1, C2 and CA. Reference is now made to optical coverage, which allows the recording to record of that which is present in the zone.

The recording devices are in this case network video cameras with suitable accessories for their open-air installation (depending on environmental conditions); said devices are often advantageously equipped with software for the remote management of their operation; steps should be taken to limit the risk of collision between the moving subjects and the recordings. For instance, products produced by the company AXIS AB can be used.

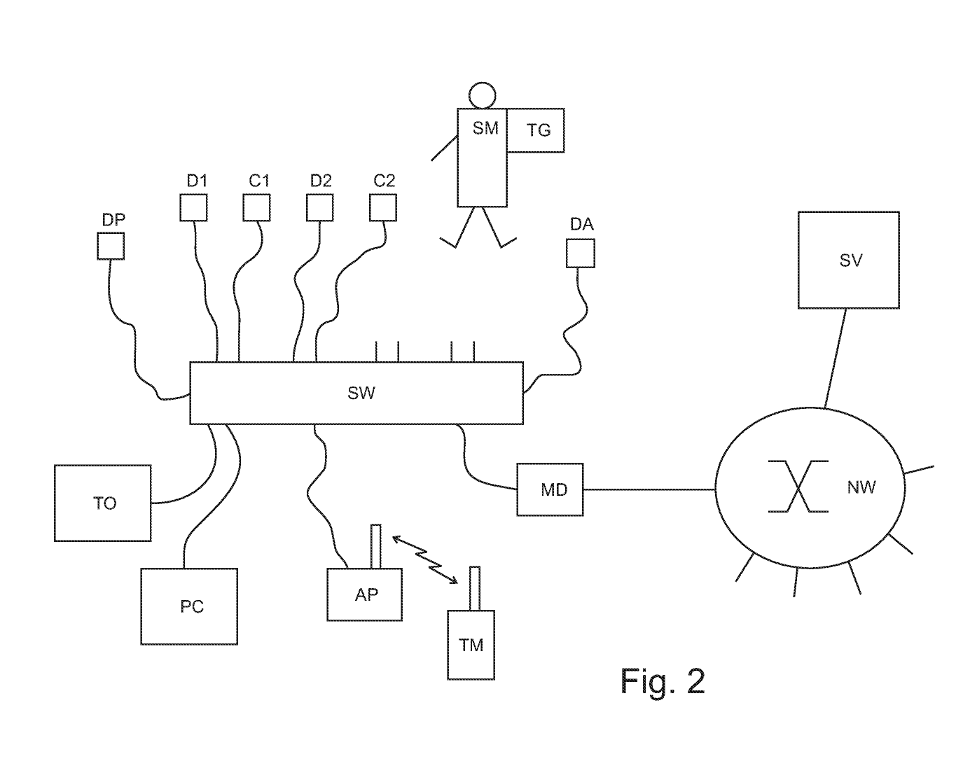

Devices DP, D1, D2, DA, CP, C1, C2 and CA are components of an embodiment of the system according to this invention, which will be described in reference to FIG. 2.

Following route TR, recordings of the moving subjects, also known as “users” (subjects S1 and S3 in the example provided in FIG. 1), will be recorded by the recording devices CP, C1, C2 and CA when they are respectively in zones ZP, Z1, Z2 and ZA, or when they are respectively detected by the detection devices DP, D1, D2 and DA.

The recordings of subjects S4 and S5 who are not “users” will not be recorded by the devices CP, C1, C2 and CA as they are not associated to identification devices and will not therefore be detected by the devices DP, D1, D2 and DA.

As regards subject S2, who is a “user”, there are essentially two possible scenarios: in the first scenario, subject S2 has reached the position shown in FIG. 1, having passed through zone ZP; in the second scenario, subject S2 did not pass through zone ZP.

In the first scenario, if subject S2 passes through zone Z1 and/or through zone Z2, he/she will be recorded by device C1 and/or by device C2, even if, for instance, he/she has stopped and/or has moved away from route TR.

In the second scenario, the recording of subject S2 will be recorded in the first zone he/she passes through. For example, if subject S2 passes through zone Z1 for the first time, he/she will be recorded by device C1. In other words, the zone from which subject S2 is deemed to be started is the first zone the subject passes through considering the logical order of the zones in route TR (ZP, Z1, Z2 and ZA). The subject's start zone is established according to a predefined procedure which will be better understood from the rest of the description.

From the foregoing it is understood that the logical order of the operations in the embodiment illustrated in FIG. 1, if the moving subject starts from zone ZP, passes through zone Z1, passes through zone Z2 and passes through zone ZA, is as follows:
1. detection of a subject in zone ZP by device DP; the subject's route is deemed as started;
2. detection of this subject in zone ZP by device CP;
3. detection of this subject in zone Z1 by device D1;
4. recording of this subject in zone Z1 by device C1;
5. detection of this subject in zone Z2 by device D2;
6. recording of this subject in zone Z2 by device C2;
7. detection of this subject in zone ZA by device DA;
8. recording of this subject in zone ZA by device CA; this route by this subject and therefore the relevant recordings are deemed concluded.

Many different orders of operations are possible other than those set out above.

A predefined procedure is applied in order to allow a subject moving in a large area that encompasses the predefined recording zones, to be recorded.

For example, if operation 1 does not take place, the subject will not have left from zone ZP and the first recording zone that he/she will encounter is zone Z1. Device C1 will therefore identify and record the subject. If operation 3 takes place twice within a predetermined time-period (the subject has passed through zone Z1 twice in a time period t1), operation 4 takes place only once. If operation 3 takes place twice, but in a time period greater than a predetermined time period (the subject has passed through zone Z1 twice in a time period t2>t1), operation 4 takes place twice thus generating two recordings of the subject in zone Z1. If operation 6 does not take place, the subject's route is automatically deemed to have been completed if a predetermined time has passed since the subject was last detected. The example provided thus allows a possible predefined procedure to be described, which allows the route taken by a subject to be defined.

The predefined procedure can envisage the use of the below criteria:
an order in which the plurality of recording zones is defined,
number of detections of a moving subject in each predefined recording zones in a predetermined time,
time interval between the identifications of a moving subject in the different, predefined recording zones,

A procedure including one or more of the described criteria therefore allows the route taken by a subject to be defined, irrespective of the zone in which the subject starts or ends his/her movement or of the order in which the subject crosses the predefined recording zones.

The order of the predefined recording zones can be defined in such a way as to represent the sequence of recording zones more frequently passed through by the subjects who is to be recorded or in the manner more in keeping with the conditions of the terrain in which the system is installed. For example, in the event of installation of the system on a ski slope, the first predefined recording zone ZP can be defined upstream of the area in which the system is to be installed while the subsequent recording zones Z1, Z2 and ZA, can be defined downstream, of the first zone ZP and each zone defined as subsequent that is placed downstream of the area defined as preceding (e.g. zone Z2 is subsequent and downstream of zone Z1). The specific order in which the recording zones are defined, as also illustrated in the embodiment of FIG. 1, advantageously sets out the most likely order for a moving subject moving from an upstream to a downstream position within the large area in which the recordings are made.

If operation 7 does not take place, the route and the relevant recordings will be concluded, e.g. if device DA does not detect the subject in zone ZA in a predetermined time period. The subject is detected, and he/she is subsequently recorded for the last time during his/her descent from device D2 in zone Z2.

Having established the order in which the plurality of recording zones is defined (in this embodiment the order is ZP, Z1, Z2 and ZA), the system implementing the method according to which this invention may envisage that after having detected the subject in zone Z2 in a temporal instant, he/she is again detected in zone ZA in a subsequent temporal instant. If the difference between the next temporal detection instant in zone ZA and the temporal detection instant in zone Z2 is greater that a preset value, the movement of the subject and consequently the recordings are not deemed as having been concluded. Thus, after having detected the subject in zone Z2 by means of device D2, the system activates a time counter. Said counter can be reset via an interrupt received by detection device DA in zone ZA. This means that the subject is continuing his/her movement and that recordings are still being made. If, on the other hand, said counter reaches a time threshold that is set in advance, it means that the subject has completed his/her movement and his/her route is deemed as having been concluded.

In the embodiment in question, said time threshold is set at 5-10 minutes.

It should be noted that said time threshold can be set according to the features of the location in which the system pursuant to this invention is installed. In addition, it can be set differently in each predefined recording zone within the same route, depending on the characteristics of each zone (e.g. a zone in which moving subjects pass at high speed, and so forth).

The possible procedure described thus allows the route actually taken by the subject to be determined. Indeed a subject may only wish to be automatically recorded in a predefined recording zone, for example a zone located at the route's TR half-way point. Thus when descending the large area the subject will only enter one recording zone (e.g. in zone Z1) and will only be recorded in that zone.

The route may therefore be defined on the basis of the recording zones that the subject actually enters. Passing through a single recording zone is the minimum limit in defining the route; while the maximum limit involves passing through all the recording zones.

This procedure thus allows the route of the moving subject to be defined. The term route refers only to the zone or plurality of subsequent zones that the subject has actually entered during his/her upstream to downstream descent within the large area in which the recordings are made.

The automatic recordings of a moving subject comprise a plurality of recording components. In fact, three recording devices are advantageously positioned in one or more predefined recording zones (schematically shown in FIG. 1 via a single recording device (CP, C1, C2 and CA). Installation of a plurality of recording devices in the zone takes place in such a way as to ensure that each recording component each has a specific perspective that differs from that of the others.

For example, subject S1 moving within zone Z1 will be recorded by three video cameras C1 positioned in such a way as to record different perspectives intrinsic to the movement made within the specific recording zone.

If the subject S1 performs a jump within zone Z1, the three video cameras will be positioned so that during the subject's jump, a first recording component is recorded by a first video camera from below; a second recording component recorded by a second video camera, from above; and lastly, a third recording component recorded by a video camera, face-on.

The term recording component refers to the recording of a subject in a predefined recording zone recorded by a device (CP, C1, C2 and CA). In the embodiment in question three recordings are made (by device C1), each of which is a recording component associated to the subject in zone Z1; 3 recording components are thus made in each predefined recording zone.

The number of recording devices in each recording zone can be selected on the basis of the specific requirements of the location in which the system according to this invention is installed and/or on the basis of the type of movement that is to be recorded.

Thus, following a subject's descent of a large area that encompasses the predefined recording zones, information is available on the route taken and the recording components of each zone that the subject has entered.

A subject event is therefore formed by associating these two pieces of information: the route taken and the recording components of each zone of the route that the subject has entered.

Each recording component contains subject identity data. Such identity data can come from metadata (e.g. text files) obtained during the identification stage and is subsequently associated to each of the recording component's vide files.

Such association can take place, for example, by writing the text file containing the identity file, in the part of the video file that accepts metadata, Such identity data can also contain information on the recording zone in which the recording components were created.

Information relating to the route taken by the user is subsequently associated to the plurality of recording components previously obtained. As in the preceding scenario, such data can be obtained from metadata in the form of text files, subsequently associated to the video files by the same means as previously set out.

It is clear to sector experts that association can take place by means other than the described means, with the same result.

The event previously described is generated by the system when a subject completes his/her descent of a large area that encompasses the recording zones. In fact, each time the subject passes through a recording zone (e.g. zone Z1), he/she is identified by the corresponding identification device, is recorded by the corresponding recording device and the recordings made are associated to the identification data, as previously described. Passing through an area defined as a subsequent area (e.g. zone Z3) before the previously established threshold time, results in the identification, recording and data association stages being repeated. If the user completes his/her movement, the previously obtained recording components are associated to the data relating to the route taken thus generating the subject event. This rule applies to both the scenario in which the subject enters into only one zone, in which case the event will be generated on elapsing of the threshold time in which the subject's route will be deemed as concluded, and the scenario in which the subject enters into all of the recording zones, in which case the event will be generated after the time required by the system to process the data, after the subject passes through the final zone (ZA),

The subject event as previously described allows recordings to be organized on the basis of the routes taken. Advantageously, access to the recordings will be simpler and more user friendly, as will become clearer from the rest of the description.

It should be noted that subjects S1, S2 and S3 and thus their recordings, are simultaneously and independently managed one from the other, i.e. the seven operations as listed above relating to subject S1 are freely mixed with those relating to subjects S2 and S3. For example, subject S2 starts from zone ZP before subject S1, but arrives in zone ZA after subject S1 (e.g. because he/she stopped as shown in FIG. 1), which constitutes no anomaly; the only effect of this situation is that the device C1 first records subject S2 and then subject S1, while device C2 first records S1 and then subject S2; in any case, as will become apparent below, the system correctly stores and organizes the recordings.

Due to the number and order of the devices and to the means of operation (detection/identification, recording and association of the recording to auxiliary data), the automatic recording can be made using fixed recording devices having a fixed recording field and possibly even fixed-focus.

This invention will typically be used for short video recordings having a duration of 5″-20″ for example; indeed, the identification devices and the detection devices, particularly those of the RFID variety, do not allow the location of the moving subject to be identified with great precision and it is not thus possible, especially when moving rapidly and at a speed that varies on a case by case basis (e.g. in the case of skiers, the speed reasonably varies between a minimum of 10 km/hr and a maximum of 70 km/hr), to guarantee that the photographic recording (the shutter opening speed for photographing a moving subject reasonably varies between a maximum of 1/100 sec and a minimum of 1/1000 sec) correctly frames the subject; the recording can clearly comprise of a rapid sequence of photographs, however this in fact constitutes a simplified form or video.

Embodiment of the system according to this invention, shown in FIG. 2, comprises a set of electronic devices that are associated one to the other by a local information network or LAN [Local Area Network]; according to this example, the LAN is connected to a WLAN (Wireless Local Area Network] in order to also allow connection to user radio-mobile terminals TM.

For the purposes of simplicity, FIG. 2 shows only one moving subject SM with his/her identification device TG and a single user radio-mobile terminal TM, such as a smartphone with Wi-Fi interface.

The LAN is created via a Switch SW. The following are connected to the Switch SW ports: a computer PC, the DP, CP, D1, C1, D2, C2, DA and CA devices, a Wi-Fi Access Point AP, an ADSL Modem MD; a device TO providing access to the recordings, with an interface for the receipt and interpretation of gesture commands; two pairs of ports are left unutilised for any further pairs of detection and recording devices, should two or more recording zones become necessary. Said connections are shown as if they are direct and cable connections; nevertheless, one or more of these connections could be a radio-frequency connection if the installation of the system according to this invention make this necessary; in addition, one or more of these connections could be an indirect connection, that is, a connection created through other devices such as relays for example.

At the core of the system is the processor PC, which controls operation and implements the method.

In the example illustrated in FIG. 2, the LAN is connected to a public information network NW, i.e. to the internet through a Modem MD; this connection allows communication between the processor PC and a server SV that is also connected to the internet. Alternatively, the processor PC could be directly connected to the server SV, e.g. through the Switch SV, but the server SV would in any case be connected to the Internet. An application, more specifically a web server application, runs on the SV to allow internet access to recordings stored on the SV; said access can take place via a user terminal that connects to the internet, e.g. via a smartphone.

A possible method of operation for the system shown in FIG. 2 is set out below and is essentially determined by a processor program that runs on the processor PC; for the purposes of simplicity, said description refers to a single moving subject. It should be noted that, even without any hardware variant, the system shown in FIG. 2 could operate differently.

The detection devices (DP, D1, D2 and DA in FIG. 2) periodically transmit interrogation signals.

When an identification device (TG in FIG. 2) receives one of these interrogation signals, or when a subject enters the coverage zone of one of the detection devices, it responds by sending the identification data contained therein; in this way, the detection device detects the presence of an identification device; as will become clearer below, the real “identification” of the moving subject is made by the computer that manages the system for the provision of the service.

Initially, the initial device (DP in FIG. 2) detects a subject (SM in FIG. 2) and signals his/her presence to the computer that manages the service provision system (PC in FIG. 2)

The management processor checks if said subject is a “user” of the service and if he/she has sufficient credit for all the recordings relating to a route (two in FIG. 2). Depending on the embodiment of this invention, the first check can essentially take place in two different ways: if the identification device transmits the identity code of a subject to the identification device, the processor for instance checks on a database (internal or external), for example, if said code is associated to a service “user”; if the identification device transmits the identification code of a device to the detection device, the processor checks on a database (internal or external) for example, if said “device code” is associated to a “user code” and thus to a service “user”. The second check could be useful, for example, in the event of a free recording service or where the “users” have unlimited credit; if these two conditions are confirmed, then the management processor records that said subject has initiated a new route and prepares to receive and store recordings of said subject; the route can be identified by both a subject identifier and, for example, by a consecutive number or by a route start time and date (i.e. time and date of detection by the initial device).

Thereafter, the first intermediate detection device (D1 in FIG. 2) detects said subject (SM in FIG. 2) within its coverage zone (Z1 in FIG. 2) and signals his/her presence to the management processor (PC in FIG. 2).

The management processor checks if said subject (SM in FIG. 2) has taken a route; if affirmative, it transmits control signals to the initial recording device (C1 in FIG. 2) so that it creates a recording; depending on the “intelligence” of the recording device, this could be a command such as “record for ten seconds” or two commands, ten seconds apart, such as “recording start” and “recording end”.

The first recording device (C1 in FIG. 2) creates a recording, on completion of which it transmits the recording to the control processor; the recording can be automatically transmitted by the recording device or requested by the management processor.

The management processor receives the recording; it subsequently associates the recording received to at least the subject's identity data (to the subject's identity code for example) as previously described; the processor can also associate information relating to the date and time the recording was made and/or the identity data of the device that made the recording and/or route data and/or data obtained on processing of the recording; lastly, it stores the recording and the associated ancillary information.

Thereafter, the second intermediate detection device (D2 in FIG. 2) detects said subject (SM in FIG. 2) within its coverage zone (Z2 in FIG. 2) and signals his/her presence to the management processor (PC in FIG. 2).

What has been said in relation to the first detection device and to the first recording device also applies to the second detection device and to the second recording device.

Lastly, the final intermediate detection device (DA in FIG. 2) detects said subject (SM in FIG. 2) within its coverage zone (ZA in FIG. 2) and signals his/her presence to the management processor (PC in FIG. 2).

The management processor checks if said subject (SM in FIG. 2) has taken a route; if affirmative, it records that said subject has completed the route taken and thus that there are no more recordings to be received and stored for said subject until said subject is again detected in the start zone.

On a case by case basis, and if necessary, the management processor, having finished making recordings of said subject, updates the credit associated to said subject—as previously mentioned, the service manager could decide to provide a free recording service and charge only for the use of the recordings made.

Transfer of the recordings with the associated data from the management processor (PC in FIG. 2) to a publication server (SV in FIG. 2) can take place at different times; according to a first possibility, the transfer could take place each time that a subject completes a route; according to a second possibility, the transfer could take place periodically, for example once an hour or once a day (during the night, for example). A good solution is to leave the recordings on the management processor for a whole day, transfer them onto the publication server the next night and delete them immediately thereafter; in this way, the next day, the management processor will be ready to receive the day's recordings and the recordings from the previous day will be available on the publication server.

Access to the recordings can vary depending on the embodiments of this invention and can take place via remote processor and/or server access. The access methods as set out in the two above cases could also be very different; for example, in the system shown in FIG. 2, in one scenario processor access takes place via WLAN and in the other scenario server access takes place via internet.

WLAN access to the recordings can take place via a user's mobile device, e.g. via a smartphone. This access method provides two further possibilities; access via a generic smartphone browser software application or via a dedicated smartphone app.

Said app could be provided when the user connects to the WLAN. After installing said app on a smartphone, a user can access (e.g. by entering login credentials such as username and password) the processor containing his/her video recordings. Indeed, the WLAN provided by the system via the switch SW, allows the mobile device to connect to the processor containing the video recordings in the exact area in which the recordings are made, even in areas where there is no wireless connection to the internet network.

A user can thus access the events that have been created thus far.

The interface and the relevant organization for viewing of the events can be grouped into different groups. A first group can include all the routes taken by the user until the time of viewing, with indication of the time that each route was taken and the zones that the user entered (e.g. Monday, 19 January—10:30—Zones: Z1 ZA and so forth). A second subgroup, which can be created by selecting the first group, can include all the recording components for a specific route, with ancillary data obtained from the metadata associated to the recording components. In addition to playing back the events, this type of access to the events also allows advance commands, such as zoom, slow down and speed up; and/or editing of the recording component footage, with the insertion of video text or light and colour effects.

Browser access provides a more basic usage of the events compared to the app access, that is, it only allows playback without the previously described advanced control and editing options.

In both cases, a user can advantageously use the events immediately after their creation.

This feature together with the variety of recording components, each having a different perspective, is particularly advantageous when using the system for educational purposes and learning a specific sports discipline.

Indeed, a sports instructor with access to his/her pupil's events, can asses—and correct their errors or inaccuracies immediately following performance of an exercise or an athletic move, thus significantly increasing educational efficiency. A user can access the events as soon as they have been created, that is, when said user concludes his/her movement. The previously described condition can apply to two scenarios: on conclusion of the user's movement in an intermediate zone (zones ZP, Z1 and Z2 in FIG. 1) or in one of the zones preceding the final zone (ZA); or once the user has passed through a zone defined as a final zone (ZA). In each of the above scenarios, the event will become available after a certain period of time has elapsed, which can fall within a maximum time equivalent to the sum of the threshold time for determining the movement of a concluded user and of the system processing time required to make the event available.

An alternative to the foregoing is however available, which allows the user access to the recording components immediately after he/she has left a recording zone, without having to wait for the system to generate the event or before the threshold time has elapsed, to determine the movement of the concluded user.

This method is particularly advantageous for users such as sports instructors who need to access the recording components of the movement of one of their pupils immediately after the movement has been performed in the recording zone to correct and assess any errors.

An additional method of accessing a user's events can take place through the device TO. In the embodiment of FIG. 2, said device comprises a monitor with a network card for LAN connection to the switch SW, thus allowing access to the processor. The device TO also comprises a device that detects the RFID tag worn by the user. The user will therefore be recognised when passing in proximity to the device TO and may access his/her own event via the same identification device that identifies him/her in the recording zones.

In addition, the terminal TO can be installed in proximity to the large area comprising the recording zones. For example, if installed on a ski slope, it can be placed downstream of the recording zones. Thus, where a user should not have a mobile device with which to view the video recordings, he/she will still be able to view them. In addition, the terminal TO being positioned in proximity to the recording zone, recordings can be advantageously played back immediately on conclusion of the user's movement.

In addition, the device TO can include an interface for receiving and interpreting the gesture commands. For example, it can be equipped with a Kinect® device. Said interface allows the user to use his/her recordings, for example by selecting the event from the available events, without any interaction that requires physical contact between the user and the device TO (for example, through the fingers); but only with gesture commands such as movement of the arms and/or hands for example). This feature advantageously allows a user to use his/her own events as soon as they have been created, without having to remove his/her sports equipment such as gloves, ski pole or other similar equipment.

It will be necessary to envisage access via identification of the person requesting access (for example, by typing “user” and “password”); this will prevent unauthorised persons from accessing the recordings and, a user profile can created, in particular, which recordings an authorised person has the right to access (for example, only his/her own recordings, the recordings of his/her pupils, or all the recordings, and so forth) and what type of access is permitted (view the recordings, download the recordings onto another medium or device, delete the recordings, associate new ancillary information to the recordings, associate the recordings to a social network profile, and so forth).

Where access to both the processor and the server is possible, two different user profiles should be created, one for the processor and one for the server, or alternatively, a single user profile, with a first section for the processor and a second section for the server. Direct access to the processor will typically only be granted to “privileged users”, such as a sports instructors, while access to the server is granted to all users, i.e. both “privileged users” and “ordinary users”; there should also be “administrative users”, with full access.

Management of both the recordings on the processor and the server can take place on an entirely manual basis (by an “administrative user” for example) or on a part manual and part automated basis; for example, in compliance with the privacy law as previously described, the recordings can be automatically deleted after a set period of time has elapsed from their creation, unless a user a requested and/or paid for the recordings to be retained for a longer period of time.

The recording devices, together with the aforementioned features, can be of the type able to achieve high-definition recordings (depending on the HD Video standard). In order to achieve optimal contrast and brightness of the video recording, in relation to the lighting conditions of the recording zones, said feature, together with the variety of perspectives obtained via the plurality of recording devices per recording zone and the positioning of the installation thereof, permits high quality recordings.

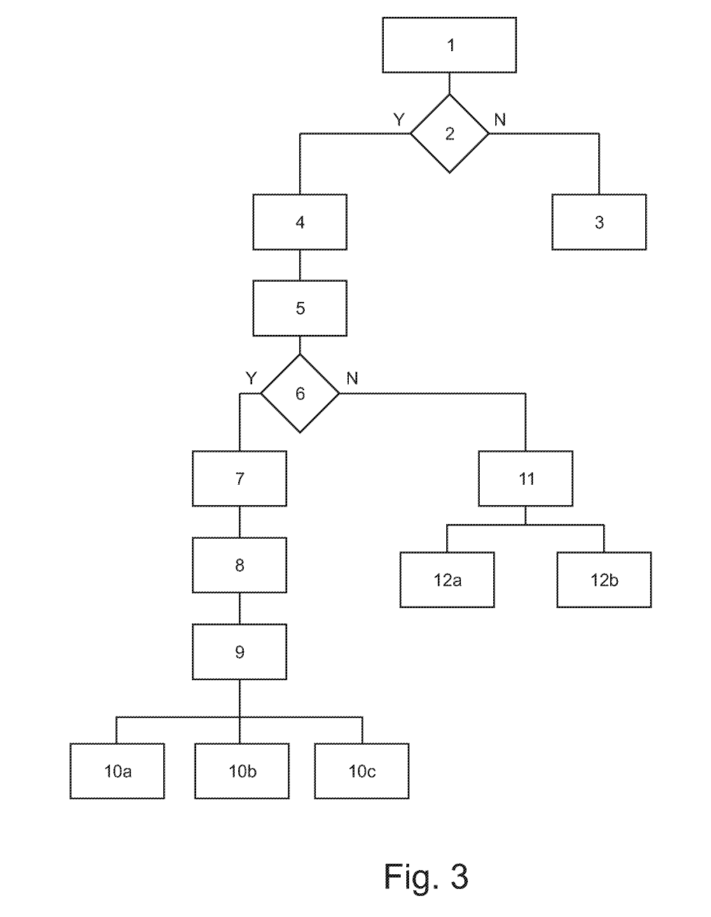

FIG. 3 shows a flow chart of the activities that a user can take part in when using a system according to this invention. The moving subject, indicated in box 1, who wishes to use the system, must first sign his/her consent for the processing of his/her personal data as shown in the test box 2. If the outcome of this check step 2 is negative (i.e. a consent signature has not been provided) it leads, following branch N in test box 2, to box 3, which indicates the end of the flow of further actions. If the outcome of said step check 2 is positive, it leads, following branch Y of test box 2, to delivery by the operator of a kit containing an RFID tag to be worn (typically an adhesive tag to be stuck onto the helmet), and the login credentials for access to the system. This set of actions is shown in box 4.

Access to the zone in which the system is installed is granted after step 4, as shown in box 5.

Following step 5 is a further test box 6, comprising of checks to ensure that the user has a mobile smartphone device with a Wi-Fi connection. If affirmative, said check step 6 leads, following branch Y of the test box 6, to connection of the user's mobile device to the system's WLAN, as shown in box 7.

After step 7, through the login credentials received in step 4, which provide system access, the user can access the system and profile his/her system user, by changing the access password and other similar settings for example, as shown in box 8. After step 8, the user accesses the system's utilisation area, i.e. the area containing the predefined recording zones, and can be automatically recorded when passing through these areas, as shown in box 9. After step 9, the user can access some events, as previously described, using a mobile device, as shown in box 10a and, additionally or alternatively, using an access device (e.g. the device TO previously described and illustrated in FIG. 2) as shown in box 10b, and, additionally or alternatively, can access the server containing the events by connecting to said server via internet, as shown in box 10c.

If, on the other hand, step 6 confirms that a user does not have a mobile device and/or does not intend to access the recordings made via said device, branch N of check box 6 is followed: the user accesses the system's utilisation area, i.e. the area containing the predefined recording zones, and can be automatically recorded when passing through these areas, as shown in box 11.

After step 11, the user can use the events, as previously described, via an access device (e.g. the device TO as previously described and illustrated in FIG. 1) as shown in box 12a, and, additionally or alternatively, can access the server containing the events by connecting to said server via internet, as shown in box 12b.

1. A method for automatically recording a moving subject associated to an electronic radio frequency identification device containing identification data of said subject, comprising:
A) automatically carrying out an identification of said subject via said identification device when said subject enters one of a plurality of predefined recording zones,
B) automatically carrying out a recording via a recording device following said identification, thus obtaining a recording component,
C) associating to said recording component, identity data deriving from said step A;
wherein a route is defined taken by said moving subject in accordance with a predefined procedure on the basis of the predefined recording zones that said moving subject has entered, and then the recording components deriving from said step C relating to said route are associated to information relating to said route, thus creating an event of said moving subject.

2. The method as claimed in claim 1, wherein said steps B and C are executed only if said identification data derived from said step A is correct.

3. The method as claimed in claim 2, wherein said identification data is deemed to be correct if said subject is correctly associated to said device and/or an electronic credit has been attested to said subject.

4. The method as claimed in claim 2, wherein said identification data deriving from said step A is checked each time that said moving subject enters one of the predefined recording zones.

5. The method as claimed in claim 1, wherein a start zone and an arrival zone are determined on the basis of said predefined procedure, wherein a recording component associated to said start zone is the first recording component of said event, and wherein a recording component associated to said arrival zone is the last recording component of said event.

6. The method as claimed in claim 1, wherein the recording device comprises a plurality of recording devices.

7. The method as claimed in claim 6, wherein at least two of the plurality of recording devices are associated to one of the predefined recording zones and are adapted to record a moving subject in said predefined recording zone with at least two corresponding perspectives.

8. The method as claimed in claim 1, wherein said step C provides to associate to a recording component also information relating to the time and date in which the recording was made and/or identity information relating to the recording device that created the recording, and/or information obtained by processing the recording.

9. The method as claimed in claim 1, wherein said predefined procedure provides one or more the following criteria:
at least a predefined order of the plurality of predefined recording zones,
a number of detections of a moving subject in one or each of the predefined recording zones in a predetermined time,
elapsed time between identification of a moving subject in different ones of the predefined recording zones.

10. The method as claimed in claim 1, wherein said event is stored in a computer and is made available by said computer for selective remote access.

11. The method as claimed in claim 10, wherein said selective remote access takes place via radio-frequency and/or via cable, in particular via WLAN and/or LAN.

12. The method as claimed in claim 10, wherein said selective remote access provides preliminary check of credentials, said credentials deriving from said identification device.

13. The method as claimed in claim 10, wherein said selective remote access takes place through a software application for mobile devices.

14. The method as claimed in claim 10, wherein said selective remote access takes place through an event playback device.

15. The method as claimed in claim 14, wherein said event playback device is equipped with an interface that is adapted to receive and interpret gesture commands.

16. The method as claimed in claim 10, wherein said computer is arranged to allow selective remote access to an event immediately after it has been created.

17. The method as claimed in claim 1, wherein said event is stored in a computer and is transferred by said computer to a server for selective access through a public information network, in particular Internet.

18. The method as claimed in claim 1, wherein said steps A, B, C are executed in relation to a plurality of moving subjects, each associated to a corresponding electronic radio-frequency identification device containing unique identification data, and wherein several moving subjects are simultaneously and independently managed.

19. An apparatus that automatically records a moving subject, wherein said subject is associated to an electronic radio frequency identification device containing identification data of said subject, said system comprising:
at least one detection device, adapted to detect the presence of an electronic radio frequency identification device in a predefined recording zone,
at least one recording device, adapted to create records of said predefined recording zone,
a computer connected to said at least one detection device and said at least one recording device
the computer configured to execute programmed instructions stored in the memory comprising:
A) automatically carrying out an identification of said subject via said identification device when said subject enters a predefined recording zone;
B) automatically carrying out a recording via a recording following said identification, thus obtaining a recording component;
C) associating to said recording component, identity data deriving from said step A;
wherein a route is defined taken by said moving subject in accordance with a predefined procedure on the basis of the predefined recording zones that said moving subject has entered, and then the recording components deriving from said step C relating to said route are associated to information relating to said route, thus creating an event of said moving subject.

20. The apparatus as claimed in claim 19, wherein the at least one detection device comprises a plurality of detection devices and the at least one recording device comprises a plurality of recording devices, said detection devices and said recording devices being connected to said computer.

21. (canceled)
